(19) United States
(12) Patent Application Publication
(10) Pub. No.: US 2011/0134605 A1
(43) Pub. Date: Jun. 9, 2011

(54) HEAT-DISSIPATING HOLE MECHANISM CAPABLE OF ADJUSTING AIRFLOW RATE AND PORTABLE COMPUTER DEVICE THEREOF

(76) Inventors: Wei-Cheng Chou, Taipei Hsien (TW); Chen-Hsien Chuang, Taipei Hsien (TW)

(21) Appl. No.: 12/948,782

(22) Filed: Nov. 18, 2010

(30) Foreign Application Priority Data
Dec. 8, 2009 (TW) 098141894

(51) Int. Cl. G06F 1/20; F24F 13/10

(52) U.S. Cl. 361/679.48; 454/358

(57) ABSTRACT

A heat-dissipating hole mechanism includes a vent structure and an adjusting pad. An opening is formed on the vent structure. The vent structure is used for guiding airflow from a fan to pass through the opening. The adjusting pad is removably disposed on the opening of the vent structure. A railing structure is formed on the adjusting pad. The railing structure is used for covering the opening so as to adjust a flow rate of the airflow.

### BACKGROUND OF THE INVENTION

1. Field of the Invention

The present invention relates to a heat-dissipating hole mechanism and a related portable computer device, and more specifically, to a heat-dissipating hole mechanism capable of adjusting airflow rate and a related portable computer device.

2. Description of the Prior Art

In general, there are many heat-generating components (e.g. a CPU, a video card, etc.) installed in a portable computer device, so a heat-dissipating device is necessary for dissipating heat generated inside the portable computer device. A conventional heat-dissipating design involves utilizing assembly of a fan and a heat sink with fins. For example, the fan may be installed on the heat sink located above a heat-generating component. In such a manner, the fan can absorb cool air from an air inlet which is usually located at the bottom of the portable computer device, and exhaust heating air from an air outlet which is usually located at a side of the portable computer device. Thus, heat generated inside the portable computer device may be dissipated accordingly via the said air convection.

The heat-dissipating efficiency of the portable computer device is directly proportional to an open ratio of a vent structure of the portable computer device (i.e. a ratio of the area of an opening and the overall area of a vent structure). A higher open ratio of the vent structure represents a lower airflow resistance, meaning that the portable computer device may have a better heat-dissipating efficiency. However, for preventing a user's finger from being scalded or slashed caused by accidentally touching a heat-dissipating device installed therein and avoiding short circuit caused by entrance of foreign objects, the open ratio of the vent structure cannot be increased unlimitedly.

As mentioned above, the portable computer device needs to have different open ratio for different use situations. However, in the prior art, a conventional vent structure may only have an opening of one size, meaning that its open ratio is not adjustable. Thus, the said structural design for the vent structure is incapable of meeting all heat-dissipating needs of the portable computer device in different use situations.

In summary, how to flexibly adjust an open ratio of a vent structure, prevent a user's finger from being scalded or slashed caused by accidentally touching a heat-dissipating device installed therein, and avoid short circuit caused by entrance of foreign objects while a user takes along the portable computer device should be a concern in the structural design of the portable computer device.

### SUMMARY OF THE INVENTION

An embodiment of the invention provides a heat-dissipating hole mechanism capable of adjusting airflow rate, the heat-dissipating hole mechanism comprising a vent structure having an opening formed thereon, the vent structure being used for guiding airflow from a fan to pass through the opening; and an adjusting pad removably disposed on the opening of the vent structure, a railing structure being formed on the adjusting pad for covering the opening so as to adjust a flow rate of the airflow.

An embodiment of the invention further provides a portable computer device capable of adjusting heat-dissipating airflow rate, the portable computer device comprising a case; a fan disposed in the case for guiding airflow in the case; and a heat-dissipating hole mechanism disposed on a position of the case corresponding to the fan, the heat-dissipating hole mechanism comprising a vent structure having an opening formed thereon, the vent structure being used for guiding the airflow from the fan to pass through the opening; and an adjusting pad removably disposed on the opening of the vent structure, a railing structure being formed on the adjusting pad for covering the opening so as to adjust a flow rate of the airflow.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a partial exploded diagram of a portable computer device according to a first embodiment of the invention.

FIG. 2 is a partial diagram of a heat-dissipating hole mechanism in FIG. 1.

FIG. 3 is a partial diagram of an adjusting pad in FIG. 2 being disposed in a vent structure.

FIG. 4 is a diagram of a heat dissipating mechanism according to a second embodiment of the invention.

FIG. 5 is a diagram of a railing structure in FIG. 4 covering an opening.

FIG. 6 is a diagram of a heat dissipating mechanism according to a third embodiment of the invention.

FIG. 7 is a diagram of the railing structure in FIG. 6 covering the opening.

FIG. 8 is a diagram of a heat dissipating mechanism according to a fourth embodiment of the invention.

FIG. 9 is a partial diagram of the railing structure in FIG. 8 covering the opening.

FIG. 10 is a diagram of a heat dissipating mechanism according to a fifth embodiment of the invention.

FIG. 11 is a diagram of the railing structure in FIG. 10 covering the opening.

### DETAILED DESCRIPTION

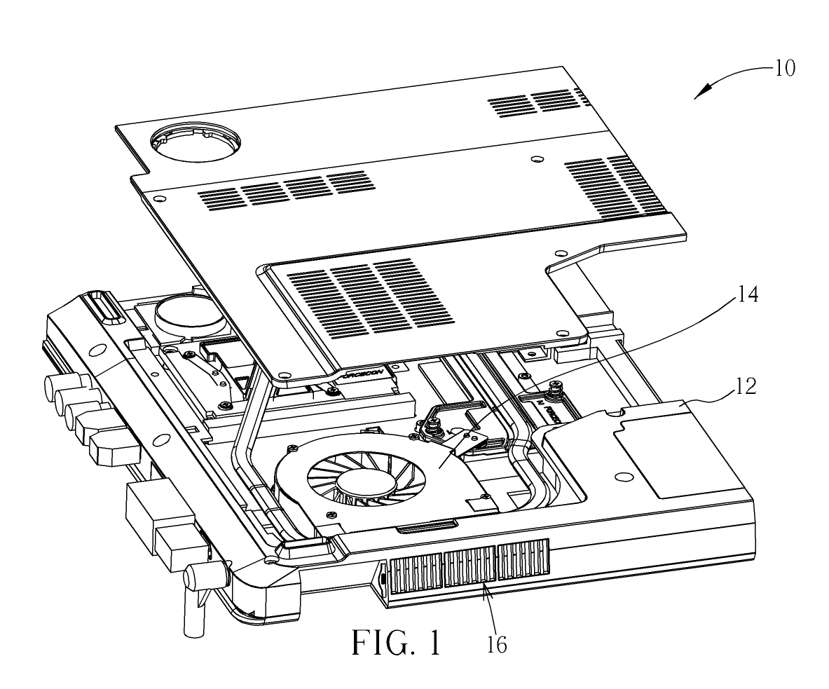

Please refer to FIG. 1, which is a partial exploded diagram of a portable computer device 10 according to a first embodiment of the invention. As shown in FIG. 1, the portable computer device 10 includes a case 12, a fan 14, and a heat-dissipating hole mechanism 16. In this embodiment, the portable computer device 10 is preferably a notebook. The case 12 is a conventional housing for containing and protecting components (e.g. a center processing unit, a motherboard, or a video card) installed in the portable computer device 10. The fan 14 is disposed in the case 12. The fan 14 is used for guiding airflow in the case 12, so as to dissipate heat generated in the portable computer device 10. Since the detailed structural design of the fan 14 is commonly seen in the prior art, the related description is therefore omitted herein.

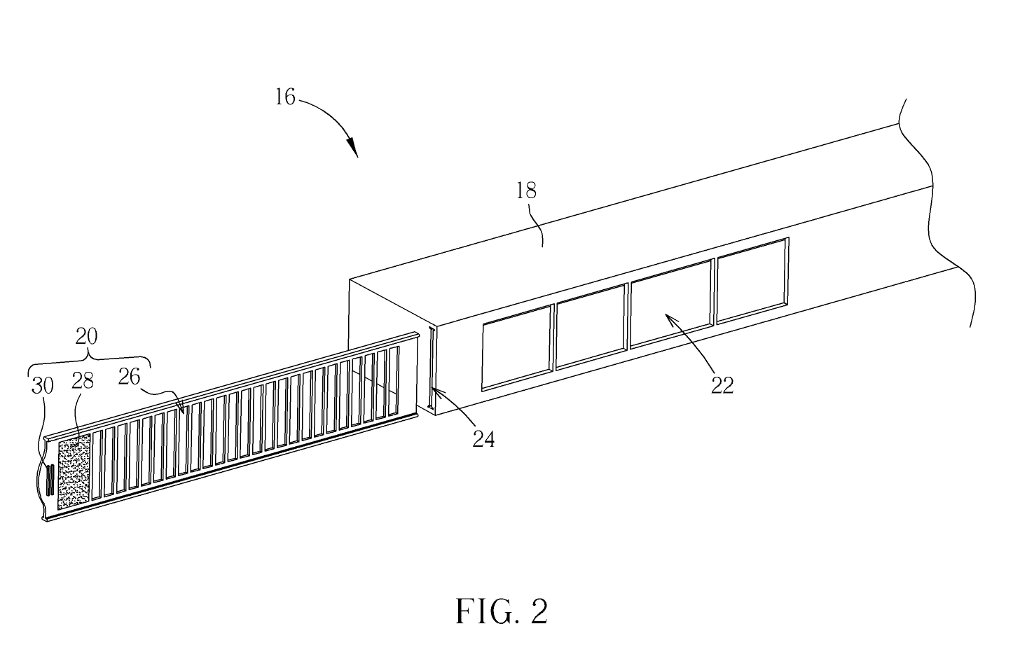

Please refer to FIG. 2, which is a partial diagram of the heat-dissipating hole mechanism 16 in FIG. 1. As shown in FIG. 2, the heat-dissipating hole mechanism 16 includes a vent structure 18 and an adjusting pad 20. At least one opening 22 (four shown in FIG. 2) and a guide rail 24 for insertion of the adjusting pad 20 are formed on the vent structure 18. The vent structure 18 is used for guiding the airflow from the fan 14 to pass through the opening 22. In this embodiment, the vent structure 18 is preferably an air outlet structure disposed at a side of the case 12, meaning that the vent structure 18 is capable of exhausting the airflow with heat in the portable computer device 10 from the opening 22 via the fan 14, but is not limited thereto. For example, the heat-dissipating hole mechanism 16 may also be applied to an air inlet structure. That is, the vent structure 18 may be capable of absorbing cool air from the opening 22 into the portable computer device 10 via the fan 14, and the related structural design may be omitted herein since it can be reasoned by analogy according to structural designs mentioned in the following embodiments. The adjusting pad 20 is disposed on the vent structure 18 in a manner of being detachable from the opening 22. A railing structure 26 is formed on the adjusting pad 20. The railing structure 26 is used for covering the opening 22 so as to adjust a flow rate of the airflow passing through the opening 22. In other words, in this embodiment, the adjusting pad 20 is slidably disposed in the guide rail 24 for adjusting a position of the railing structure 26 relative to the opening 22. When the adjusting pad 20 is disposed through the guide rail 24 to install on the vent structure 18, the adjusting pad 20 may utilize the railing structure 26 to cover the opening 22, so as to reduce the flow rate of the airflow passing through the opening 22. On the other hand, when the adjusting pad 20 is detached from the guide rail 24 so as to make the railing structure 26 separate from the opening 22, the flow rate of the airflow passing through the opening 22 may be increased accordingly since the railing structure 26 no longer covers the opening 22.

Furthermore, as shown in FIG. 2, a rough surface 28 and a protruding portion 30 are formed on a side of the adjusting pad 20 corresponding to the railing structure 26, respectively. The rough surface 28 is used for interfacing with the vent structure 18 so as to fix a position of the adjusting pad 20 relative to the vent structure 18 when the railing structure 26 covers the opening 22. The protruding portion 30 is used for abutting against a side of the vent structure 18 so as to constrain motion of the adjusting pad 20 relative to the vent structure 18 when the railing structure 26 covers the opening 22.

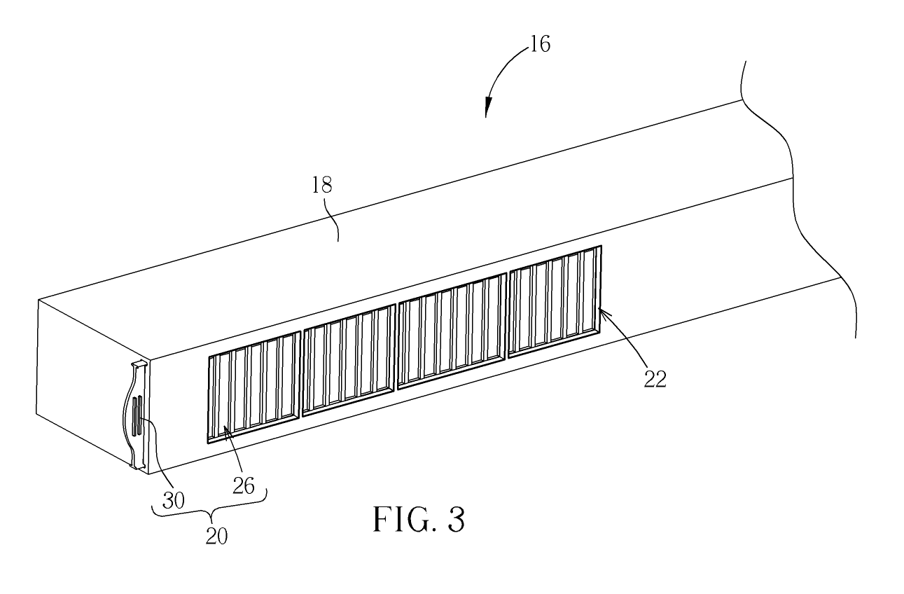

More detailed description for the heat-dissipating hole mechanism 16 is provided as follows. Please refer to FIG. 2 and FIG. 3. FIG. 3 is a partial diagram of the adjusting pad 20 in FIG. 2 being disposed in the vent structure 18. When a user takes along the portable computer device 10 or the portable computer device 10 is in a turn-off state or in a low heat-generating state (e.g. a power-saving mode), the user may align the adjusting pad 20 in FIG. 2 with the guide rail 24 of the vent structure 18, and then insert the adjusting pad 20 into the vent structure 18 along the guide rail 24 until the adjusting pad 20 is moved to a position as shown in FIG. 3. At this time, the rough surface 28 of the adjusting pad 20 may interface with the vent structure 18 so as to fix a position of the adjusting pad 20 relative to the vent structure 18, meaning that the adjusting pad 20 can be fixed at the position as shown in FIG. 3 by friction force generated from interference between the rough surface 28 and the vent structure 18. Simultaneously, the protruding portion 30 may also abut against a side of the vent structure 18 (as shown in FIG. 3), so as to prevent the adjusting pad 20 from being completely inserted into the vent structure 18 and then not easily extracted from the vent structure 18. In such a manner, via the said structural design for utilizing the railing structure 26 to cover the opening 22, the portable computer device 10 may reduce the open ratio of the vent structure 18, so as to avoid short circuit caused by entrance of foreign objects and prevent the user's finger from being scalded or slashed caused by accidentally touching a heat-dissipating device installed therein. Furthermore, covering of the railing structure 26 on the opening 22 may not cause overheating of the portable computer device 10 since the portable computer device 10 is in a turn-off state or in a low heat-generating state.

On the other hand, if the portable computer device 10 is in a high heat-generating state (e.g. its CPU running in a high speed mode) or the user operates the portable computer device 10 on a table, it means that heat generated inside the portable computer device 10 needs to be dissipated quickly for preventing overheating of the portable computer device 10 or means that foreign objects cannot enter the portable computer device 10 via the vent structure 18 easily. Thus, the user may pull the adjusting pad 20 to move along the guide rail 24 from the position as shown in FIG. 3 to a position as shown in FIG. 2, so as to cause the opening 22 not to be covered by the railing structure 26. In such a manner, the flow rate of the airflow passing through the opening 22 may be increased accordingly, so that the purpose of improving the heat-dissipating efficiency of the portable computer device 10 may be achieved.

It should be mentioned that the position of the adjusting pad 20 relative to the opening 22 is not limited to FIG. 2 and FIG. 3. That is, the user may modify a position of the railing structure 26 relative to the openings 22 for meeting different heat-dissipating needs of the portable computer device 10 since the adjusting pad 20 is movably disposed in the guide rail 24. For example, the user may move the adjusting pad 20 to a position where the railing structure 26 only covers two openings 22 of the vent structure 18.

In summary, via the structural design of the adjusting pad 20 being capable of selectively covering the opening 22 of the vent structure 18 or not, the flow rate of the airflow passing through the opening 22 can be adjustable. In other words, no matter the portable computer device 10 is in a low heat-generating state or in a high heat-generating state, the portable computer device 10 may have the corresponding heat-dissipating efficiency via the said structural design.

Furthermore, in the invention, the structural design for connecting the adjusting pad to the vent structure is not limited to the said embodiment. In the following, other similar structural designs are described in detail.

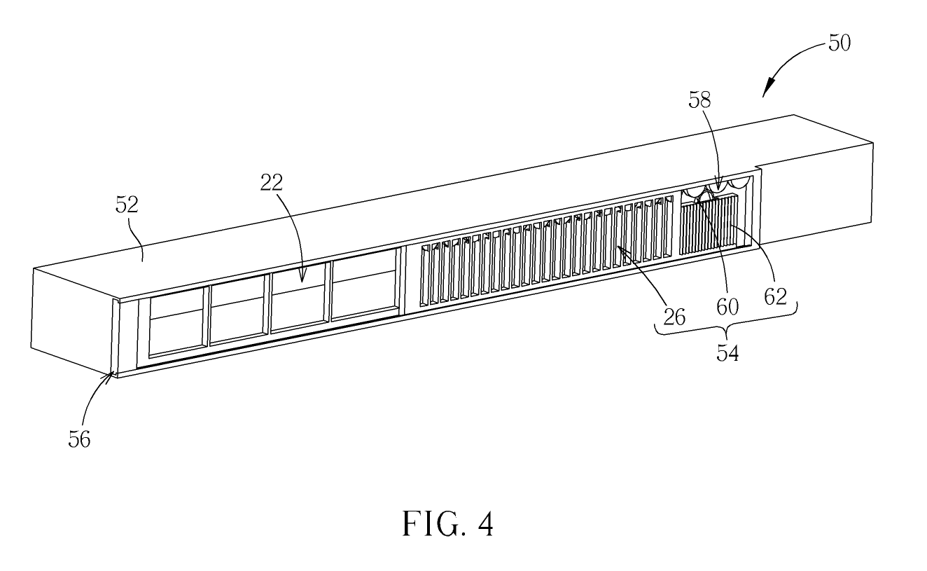

Please refer to FIG. 4, which is a diagram of a heat-dissipating hole mechanism 50 according to a second embodiment of the invention. Components both mentioned in the first embodiment and the second embodiment represent similar functions or structures, and the related description is omitted herein. The major difference between the heat-dissipating hole mechanism 50 in the second embodiment and the heat-dissipating hole mechanism 16 is the structural design for positioning the adjusting pad on the vent structure. As shown in FIG. 4, the heat-dissipating hole mechanism 50 includes a vent structure 52 and an adjusting pad 54. A guide rail 56 is formed in the vent structure 52 for guiding the adjusting pad 54 to move back and forth relative to the vent structure 52. A tooth structure 58 is formed on the guide rail 56, and an elastic component 60 is formed on the adjusting pad 54 correspondingly. The elastic component 60 is used for engaging with the tooth structure 58 so as to position the adjusting pad 54 on the vent structure 52. Furthermore, a rough surface 62 is formed on a position of the adjusting pad 54 corresponding to the elastic component 60. The rough surface 62 preferably includes a plurality of protruding bars for allowing a user to exert force on the adjusting pad 54, so as to move the adjusting pad 54 along the guide rail 56 relative to the vent structure 52 conveniently.

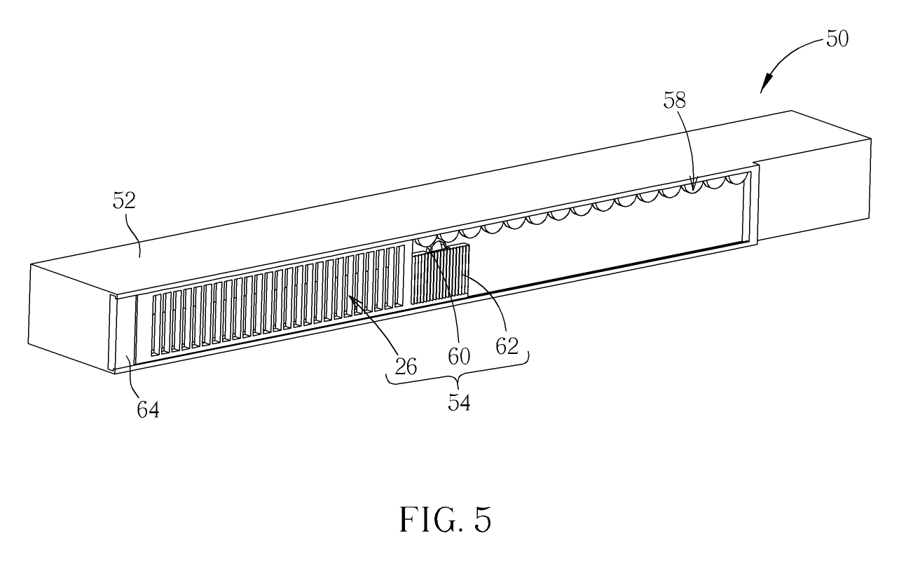

More detailed description for the heat-dissipating hole mechanism 50 is provided as follows. Please refer to FIG. 4 and FIG. 5. FIG. 5 is a diagram of the railing structure 26 in FIG. 4 covering the opening 22. When a user takes along the portable computer device 10 or the portable computer device 10 is in a turn-off state or in a low heat-generating state (e.g. a power-saving mode), the user may exert force upon the rough surface 62 to push the adjusting pad 54 along the guide rail 56 from a position as shown in FIG. 4 to a position as shown in FIG. 5 relative to the vent structure 52. At this time, the elastic component 60 may be engaged with one slot on the tooth structure 58 so as to fix a position of the adjusting pad 54 relative to the vent structure 52. That is, via engagement of the adjusting pad 54 and the tooth structure 58, the adjusting pad 54 can be fixed at the position as shown in FIG. 5. Furthermore, as shown in FIG. 5, the heat-dissipating hole mechanism 50 also includes a block 64 disposed on the guide rail 56. The block 64 is used for constraining motion of the adjusting pad 54 relative to the vent structure 52 so as to prevent the adjusting pad 54 from coming off the guide rail 56. In this embodiment, the block 64 is preferably made of rubber material.

In such a manner, via the said structural design of the railing structure 26 covering the opening 22, the portable computer device 10 may reduce the open ratio of the vent structure 52, so as to avoid short circuit caused by entrance of foreign objects and prevent the user's finger from being scalded or slashed caused by accidentally touching a heat-dissipating device installed therein. Furthermore, as mentioned above, covering of the railing structure 26 on the opening 22 may not cause overheating of the portable computer device 10 since the portable computer device 10 is in a turn-off state or in a low heat-generating state.

On the other hand, if the portable computer device 10 is in a high heat-generating state (e.g. its CPU running in a high speed mode) or the user operates the portable computer device 10 on a table, it means that heat generated inside the portable computer device 10 needs to be dissipated efficiently for preventing overheating of the portable computer device 10 or means that foreign objects may not enter the portable computer device 10 via the vent structure 52 easily. Thus, the user may exert force upon the rough surface 62 to push the adjusting pad 54 from the position as shown in FIG. 5 to the position as shown in FIG. 4, so as to cause the opening 22 not to be covered by the railing structure 26. In such a manner, the flow rate of the airflow passing through the opening 22 may be increased accordingly, so that the purpose of improving the heat-dissipating efficiency of the portable computer device 10 may be achieved.

Similarly, a position of the adjusting pad 54 relative to the opening 22 is not limited to FIG. 4 and FIG. 5. That is, the user may modify the engaging position of the elastic component 60 on the tooth structure 58 for meeting different heat-dissipating needs of the portable computer device 10. For example, the user may push the adjusting pad 54 to engage the elastic component 60 with a center slot on the tooth structure 58, so as to cause the railing structure 26 only to cover two openings 22 of the vent structure 52.

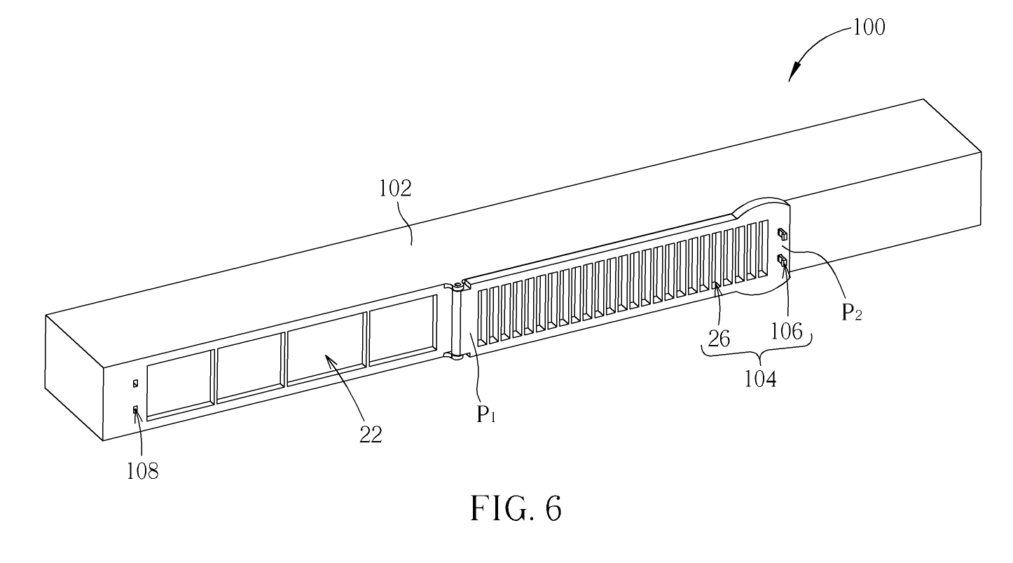

Next, please refer to FIG. 6, which is a diagram of a heat-dissipating hole mechanism 100 according to a third embodiment of the invention. Components both mentioned in the first embodiment and the third embodiment represent similar functions or structures, and the related description is omitted herein. The major difference between the heat-dissipating hole mechanism 100 in the third embodiment and the heat-dissipating hole mechanism 16 is the structural design for connecting the adjusting pad to the vent structure. As shown in FIG. 6, the heat-dissipating hole mechanism 100 includes a vent structure 102 and an adjusting pad 104. A first end P₁ of the adjusting pad 104 is pivotally connected to a side of the opening 22. At least one positioning hook 106 (two shown in FIG. 6) is formed at a second end P₂ of the adjusting pad 104, and at least one positioning hole 108 (two shown in FIG. 6) is formed on the vent structure 102 correspondingly. The positioning hook 106 is used for engaging with the corresponding positioning hole 108, so as to fix a position of the adjusting pad 104 relative to the vent structure 102.

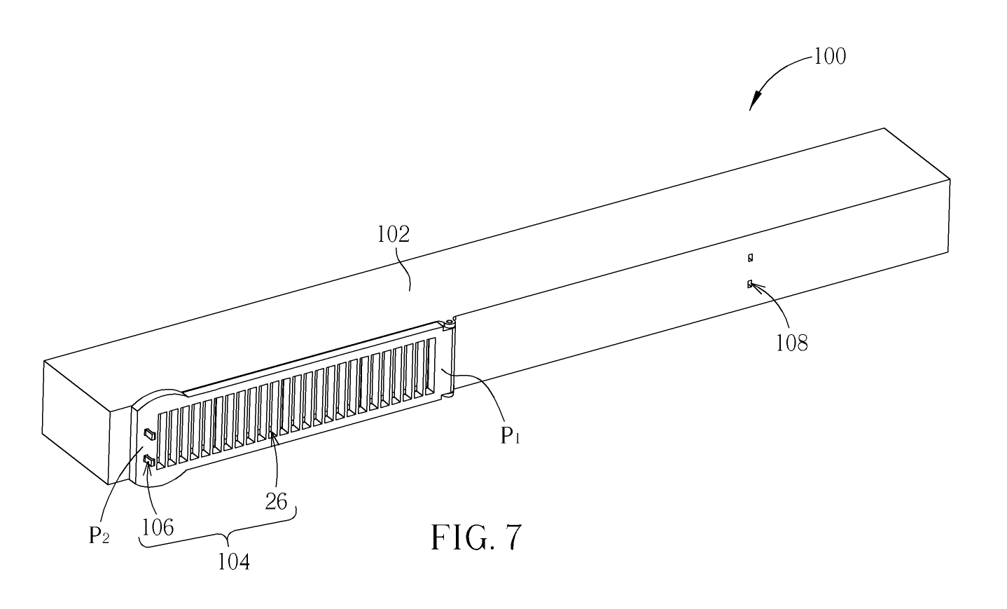

More detailed description for the heat-dissipating hole mechanism 100 is provided as follows. Please refer to FIG. 6 and FIG. 7. FIG. 7 is a diagram of the railing structure 26 in FIG. 6 covering the opening 22. When a user takes along the portable computer device 10 or the portable computer device 10 is in a turn-off state or in a low heat-generating state (e.g. a power-saving mode), the user may pull the adjusting pad 104 to rotate from a position as shown in FIG. 6 to a position as shown in FIG. 7 relative to the vent structure 102. At this time, the positioning hook 106 can be engaged with the corresponding positioning hole 108 so as to fix a position of the adjusting pad 104 relative to the vent structure 102. That is, via engagement of the positioning hook 106 and the positioning hole 108, the adjusting pad 104 can be fixed at the position as shown in FIG. 7.

In such a manner, via the said structural design of the railing structure 26 covering the opening 22, the portable computer device 10 may reduce the open ratio of the vent structure 102, so as to avoid short circuit caused by entrance of foreign objects and prevent the user's finger from being scalded or slashed caused by accidentally touching a heat-dissipating device installed therein. Furthermore, as mentioned above, covering of the railing structure 26 on the opening 22 may not cause overheating of the portable computer device 10 since the portable computer device 10 is in a turn-off state or in a low heat-generating state.

On the other hand, if the portable computer device 10 is in a high heat-generating state (e.g. its CPU running in a high speed mode) or the user operates the portable computer device 10 on a table, it means that heat generated inside the portable computer device 10 needs to be dissipated quickly for preventing overheating of the portable computer device 10 or means that foreign objects may not enter the portable computer device 10 via the vent structure 102 easily. Thus, the user may pull the adjusting pad 104 to rotate from the position as shown in FIG. 7 to the position as shown in FIG. 6, so as to cause the opening 22 not to be covered by the railing structure 26. In such a manner, the flow rate of the airflow passing through the opening 22 may be increased accordingly, so that the purpose of improving the heat-dissipating efficiency of the portable computer device 10 may be achieved.

Furthermore, as shown in FIG. 6 and FIG. 7, the structural design for engaging the positioning hook 106 with the positioning hole 108 may also be utilized to fix the adjusting pad 104 to the vent structure 102 at the position as shown in FIG. 6. That is, the positioning hook 106 may also be formed at the other side of the adjusting pad 104, and the positioning hole 108 may be formed on the vent structure 102 correspondingly. Thus, via engagement of the positioning hook 106 and the positioning hole 108, the adjusting pad 104 may also be fixed at the position as shown in FIG. 6.

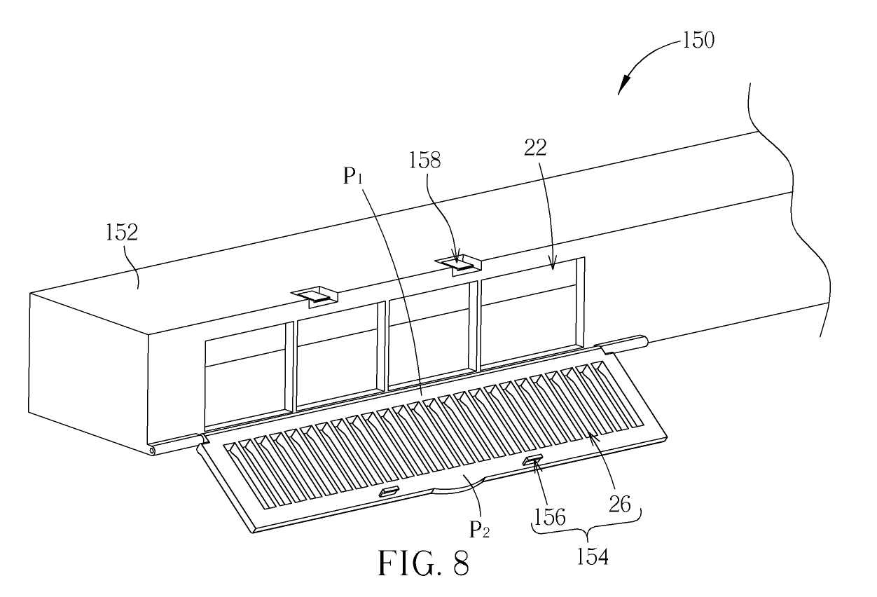

Please refer to FIG. 8, which is a diagram of a heat-dissipating hole mechanism 150 according to a fourth embodiment of the invention. Components both mentioned in the third embodiment and the fourth embodiment represent similar functions or structures, and the related description is omitted herein. The major difference between the heat-dissipating hole mechanism 150 in the fourth embodiment and the heat-dissipating hole mechanism 100 is the structural design for connecting the adjusting pad to the vent structure. As shown in FIG. 8, the heat-dissipating hole mechanism 150 includes a vent structure 152 and an adjusting pad 154. A first end P₁ of the adjusting pad 154 is pivotally connected to a side of the opening 22. At least one first hook 156 (two shown in FIG. 8) is formed at a second end P₂ of the adjusting pad 154, and at lease one second hook 158 (two shown in FIG. 8) is formed on the vent structure 152 correspondingly. The first hook 156 is used for engaging with the corresponding second hook 158 so as to fix a position of the adjusting pad 154 relative to the vent structure 152.

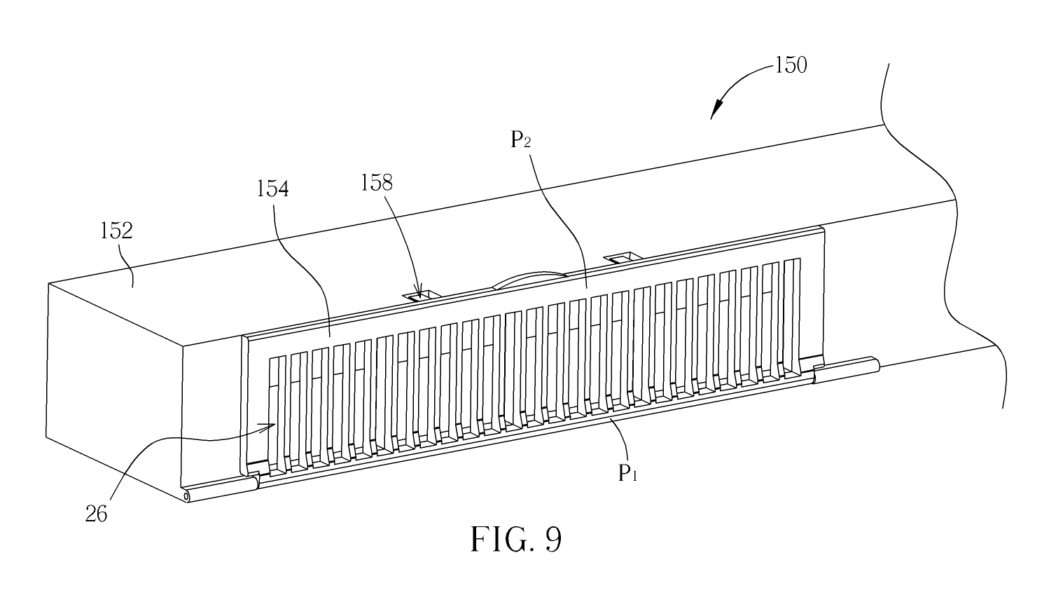

Since the heat-dissipating hole mechanism 150 and the heat-dissipating hole mechanism 100 have the similar structural design, detailed description for the heat-dissipating hole mechanism 150 may be reasoned according to the third embodiment. In brief, when the open rate of the vent structure 152 needs to be reduced, a user may pull the adjusting pad 154 to rotate from a position as shown in FIG. 8 to a position as shown in FIG. 9 relative to the vent structure 152, wherein FIG. 9 is a partial diagram of the railing structure 26 covering the opening 22. At this time, the first hook 156 is engaged with the corresponding second hook 158, so as to fix the adjusting pad 154 to the vent structure 152. On the other hand, when the heat-dissipating efficiency of the portable computer device 10 needs to be increased, the user just needs to pull the adjusting pad 154 to rotate from the position as shown in FIG. 9 to the position as shown in FIG. 8, so as to cause the opening 22 not to be covered by the railing structure 26.

Compared with the heat-dissipating hole mechanism 100 in the third embodiment, the heat-dissipating hole mechanism 150 may further have a function of separating airflow when the adjusting pad 154 is located at the position as shown in FIG. 8. For example, if the portable computer device 10 utilizes the fan 14 to absorb cool air from the bottom of the case 12 in FIG. 1 and exhaust heating air from the opening 22, the portable computer device 10 may utilize the railing structure 26 to prevent the heating air from flowing downward and then being absorbed into the bottom of the case by the fan 14. Furthermore, the structural designs for fixing the adjusting pad to the vent structure mentioned in the third embodiment and the fourth embodiment may be applied to each other. For example, the heat-dissipating hole mechanism 150 may also utilize the structural design for engaging the positioning hook with the positioning hole mentioned in the third embodiment instead to fix the adjusting pad 154 to the vent structure 152.

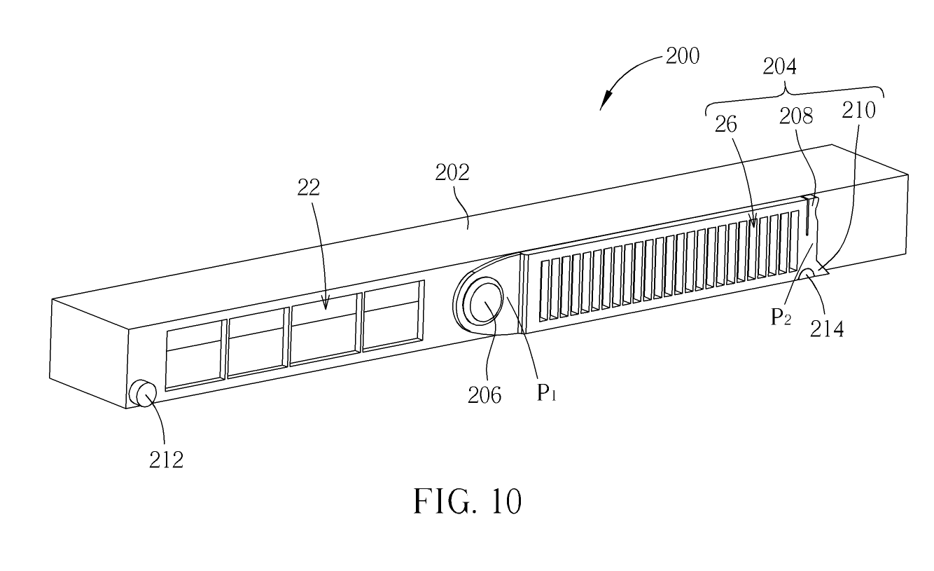

Finally, please refer to FIG. 10, which is a diagram of a heat-dissipating hole mechanism 200 according to a fifth embodiment of the invention. Components both mentioned in the fifth embodiment and the third embodiment represent similar functions or structures, and the related description is omitted herein. The major difference between the heat-dissipating hole mechanism 200 in the fifth embodiment and the heat-dissipating hole mechanism 100 is the structural design for pivotally connecting the adjusting pad to the vent structure. As shown in FIG. 10, the heat-dissipating hole mechanism 200 includes a vent structure 202 and an adjusting pad 204. A pivot pillar 206 is formed at a position of the vent structure 202 corresponding to a side of the opening 22. A first end P₁ of the adjusting pad 204 is disposed through the pivot pillar 206 so that the adjusting pad 204 is capable of rotating relative to the vent structure 202. A first engaging structure 208 and a second engaging structure 210 are formed at a second end P₂ of the adjusting pad 204, respectively. In this embodiment, the first engaging structure 208 may preferably be an elastic arm for abutting against a first pillar 212 on the vent structure 202 when the adjusting pad 204 rotates to a first position covering the opening 22. The second engaging structure 210 may preferably be a hook for engaging with a second pillar 214 on the vent structure 202 when the adjusting pad 204 rotates to a second position not to cover the opening 22.

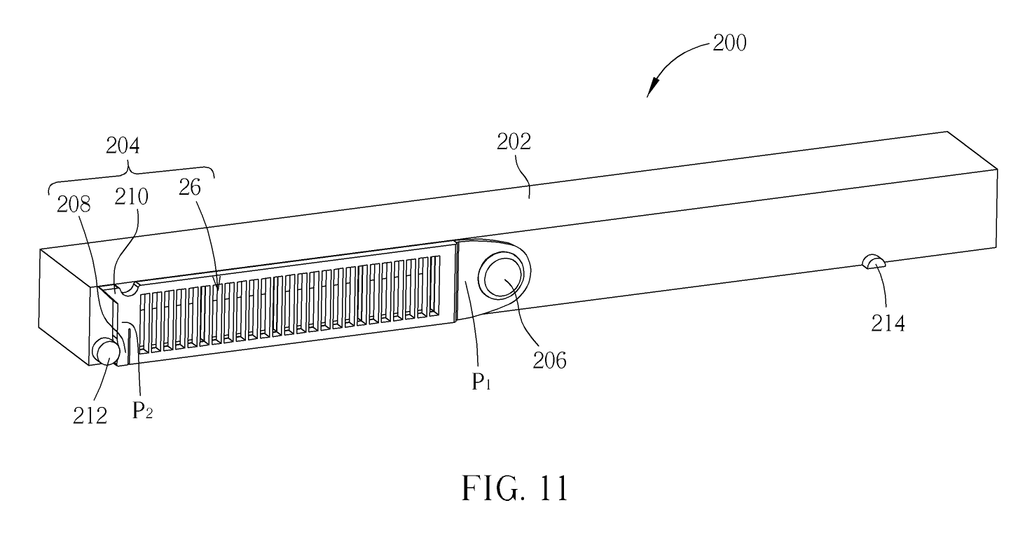

More detailed description for the heat-dissipating hole mechanism 200 is provided as follows. Please refer to FIG. 10 and FIG. 11. FIG. 11 is a diagram of the railing structure 26 in FIG. 10 covering the opening 22. When a user takes along the portable computer device 10 or the portable computer device 10 is in a turn-off state or in a low heat-generating state (e.g. a power-saving mode), the user may pull the adjusting pad 204 to rotate from the second position as shown in FIG. 10 to the first position as shown in FIG. 11 relative to the vent structure 202. At this time, the first engaging structure 208 abuts against the first pillar 212 so as to fix a position of the adjusting pad 204 relative to the vent structure 202. That is, via abutting of the first engaging structure 208 against the first pillar 212, the adjusting pad 204 can be fixed at the first position as shown in FIG. 11.

In such a manner, via the said structural design of the railing structure 26 covering the opening 22, the portable computer device 10 may reduce the open ratio of the vent structure 202, so as to avoid short circuit caused by entrance of foreign objects and prevent the user's finger from being scalded or slashed caused by accidentally touching a heat-dissipating device installed therein. Furthermore, as mentioned above, covering of the railing structure 26 on the opening 22 may not cause overheating of the portable computer device 10 since the portable computer device 10 is in a turn-off state or in a low heat-generating state.

On the other hand, if the portable computer device 10 is in a high heat-generating state (e.g. its CPU running in a high speed mode) or the user operates the portable computer device 10 on a table, it means that heat generated inside the portable computer device 10 needs to be dissipated quickly for preventing overheating of the portable computer device 10 or means that foreign objects may not enter the portable computer device 10 via the vent structure 202 easily. Thus, the user may pull the adjusting pad 204 to rotate from the first position as shown in FIG. 11 to the second position as shown in FIG. 10, so as to cause the opening 22 not to be covered by the railing structure 26. At this time, as shown in FIG. 10, the second engaging structure 210 is engaged with the second pillar 214 so as to fix the adjusting pad 204 at the second position as shown in FIG. 10. In such a manner, the flow rate of the airflow passing through the opening 22 may be increased accordingly, so that the purpose of improving the heat-dissipating efficiency of the portable computer device 10 may be achieved.

The said structural designs for abutting the first engaging structure 208 against the first pillar 212 and engaging the second engaging structure 210 with the second pillar 214 may be applied to each other. That is, when the adjusting pad 204 rotates to the first position, the heat-dissipating hole mechanism 200 may utilize the structural design for engaging the second engaging structure 210 with the second pillar 214 instead to fix the adjusting pad 204 at the first position as shown in FIG. 11. Similarly, when the adjusting pad 204 rotates to the second position, the heat-dissipating hole mechanism 200 may also utilize the structural design for abutting the first engaging structure 208 against the first pillar 212 instead to fix the adjusting pad 204 at the second position as shown in FIG. 10. Furthermore, the said structural designs may also be applied to the third or the fourth embodiment.

Compared with the prior art utilizing a vent structure of one size, the invention utilizes the adjusting pad, which is capable of sliding or rotating relative to the vent structure, to adjust a position of the railing structure relative to the opening with a high open ratio or a low open ratio, so that an overall open ratio of the heat-dissipating hole mechanism can be adjustable. In such a manner, via the structural design of the adjusting pad being capable of selectively covering the opening of the vent structure or not, no matter the portable computer device is in a low or a high heat-generating state, the portable computer device may have the corresponding heat-dissipating efficiency. Furthermore, via the structural design of the railing structure with the low open ratio covering the opening, the invention may also avoid short circuit caused by entrance of foreign objects and prevent a user's finger from being scalded or slashed caused by accidentally touching a heat-dissipating device installed therein.

Those skilled in the art will readily observe that numerous modifications and alterations of the device and method may be made while retaining the teachings of the invention.

What is claimed is:

1. A heat-dissipating hole mechanism capable of adjusting airflow rate, the heat-dissipating hole mechanism comprising:
a vent structure having an opening formed thereon, the vent structure being used for guiding airflow from a fan to pass through the opening; and
an adjusting pad removably disposed on the opening of the vent structure, a railing structure being formed on the adjusting pad for covering the opening so as to adjust a flow rate of the airflow.

2. The heat-dissipating hole mechanism of claim 1, wherein a guide rail is formed in the vent structure, and the adjusting pad is slidably disposed in the guide rail for adjusting a position of the railing structure relative to the opening.

3. The heat-dissipating hole mechanism of claim 2, wherein a rough surface is formed on the adjusting pad, and when the railing structure covers the opening, the rough surface interfaces with the vent structure so as to fix a position of the adjusting pad relative to the opening.

4. The heat-dissipating hole mechanism of claim 2, wherein a protruding portion is formed on an end of the adjusting pad and is used for abutting against a side of the vent structure, so as to constrain motion of the adjusting pad relative to the vent structure.

5. The heat-dissipating hole mechanism of claim 2, wherein a tooth structure is formed in the guide rail, and an elastic component is formed on the adjusting pad and is used for engaging with the tooth structure when the adjusting pad is disposed on the guide rail, so as to fix a position of the adjusting pad relative to the vent structure.

6. The heat-dissipating hole mechanism of claim 5, wherein a rough surface is formed at a position of the adjusting pad corresponding to the elastic component.

7. The heat-dissipating hole mechanism of claim 2 further comprising a block disposed on the guide rail for constraining motion of the adjusting pad relative to the vent structure.

8. The heat-dissipating hole mechanism of claim 7, wherein the block is made of rubber material.

9. The heat-dissipating hole mechanism of claim 1, wherein a first end of the adjusting pad is pivotally connected to a side of the opening.

10. The heat-dissipating hole mechanism of claim 9, wherein a pivot pillar is formed at a position of the vent structure corresponding to the side of the opening, and the first end of the adjusting pad is rotatably disposed on the pivot pillar.

11. The heat-dissipating hole mechanism of claim 9, wherein a positioning hook is formed on a second end of the adjusting pad, a positioning hole is formed on the vent structure, and the positioning hook is used for engaging with the positioning hole so as to fix a position of the adjusting pad relative to the vent structure.

12. The heat-dissipating hole mechanism of claim 9, wherein a first hook is formed on a second end of the adjusting pad, a second hook is formed on the vent structure, and the first hook is used for engaging with the second hook so as to fix a position of the adjusting pad relative to the vent structure.

13. The heat-dissipating hole mechanism of claim 9, wherein a first engaging structure is formed on a second end of the adjusting pad, and is used for engaging with a first pillar of the vent structure when the adjusting pad rotates to a first position covering the opening.

14. The heat-dissipating hole mechanism of claim 13, wherein the first engaging structure is an elastic arm for abutting against the first pillar.

15. The heat-dissipating hole mechanism of claim 13, wherein a second engaging structure is formed on the second end of the adjusting pad, and is used for engaging with a second pillar of the vent structure when the adjusting pad rotates to a second position not to cover the opening.

16. The heat-dissipating hole mechanism of claim 15, wherein the second engaging structure is a hook for engaging with the second pillar.

17. A portable computer device capable of adjusting heat-dissipating airflow rate, the portable computer device comprising:
a case;
a fan disposed in the case for guiding airflow in the case; and
a heat-dissipating hole mechanism disposed on a position of the case corresponding to the fan, the heat-dissipating hole mechanism comprising:
a vent structure having an opening formed thereon, the vent structure being used for guiding the airflow from the fan to pass through the opening; and
an adjusting pad removably disposed on the opening of the vent structure, a railing structure being formed on the adjusting pad for covering the opening so as to adjust a flow rate of the airflow.

18. The portable computer device of claim 17, wherein a guide rail is formed in the vent structure, and the adjusting pad is slidably disposed in the guide rail for adjusting a position of the railing structure relative to the opening.

19. The portable computer device of claim 18, wherein a rough surface is formed on the adjusting pad, and when the railing structure covers the opening, the rough surface interfaces with the vent structure so as to fix a position of the adjusting pad relative to the opening.

20. The portable computer device of claim 18, wherein a protruding portion is formed on an end of the adjusting pad, and is used for abutting against a side of the vent structure so as to constrain motion of the adjusting pad relative to the vent structure.

21. The portable computer device of claim 18, wherein a tooth structure is formed in the guide rail, an elastic component is formed on the adjusting pad, and the elastic component is used for engaging with the tooth structure when the adjusting pad is disposed on the guide rail, so as to fix a position of the adjusting pad relative to the vent structure.

22. The portable computer device of claim 21, wherein a rough surface is formed at a position of the adjusting pad corresponding to the elastic component.

23. The portable computer device of claim 18, wherein the heat-dissipating hole mechanism further comprises a block disposed on the guide rail for constraining motion of the adjusting pad relative to the vent structure.

24. The portable computer device of claim 23, wherein the block is made of rubber material.

25. The portable computer device of claim 17, wherein a first end of the adjusting pad is pivotally connected to a side of the opening.

26. The portable computer device of claim 25, wherein a pivot pillar is formed at a position of the vent structure corresponding to the side of the opening, and the first end of the adjusting pad is rotatably disposed on the pivot pillar.

27. The portable computer device of claim 25, wherein a positioning hook is formed on a second end of the adjusting pad, a positioning hole is formed on the vent structure, and the positioning hook is used for engaging with the positioning hole so as to fix a position of the adjusting pad relative to the vent structure.

28. The portable computer device of claim 25, wherein a first hook is formed on a second end of the adjusting pad, a second hook is formed on the vent structure, and the first hook is used for engaging with the second hook so as to fix a position of the adjusting pad relative to the vent structure.

29. The portable computer device of claim 25, wherein a first engaging structure is formed on a second end of the adjusting pad, and is used for engaging with a first pillar of the vent structure when the adjusting pad rotates to a first position covering the opening.

30. The portable computer device of claim 29, wherein the first engaging structure is an elastic arm for abutting against the first pillar.

31. The portable computer device of claim 29, wherein a second engaging structure is formed on the second end of the adjusting pad, and the second engaging structure is used for engaging with a second pillar of the vent structure when the adjusting pad rotates to a second position not to cover the opening.

32. The portable computer device of claim 31, wherein the second engaging structure is a hook for engaging with the second pillar.
